(19) United States
(12) Patent Application Publication
(10) Pub. No.: US 2016/0044964 A1
(43) Pub. Date: Feb. 18, 2016

(54) ATOMIZER AND ELECTRONIC CIGARETTE

(71) Applicant: HUIZHOU KIMREE TECHNOLOGY CO., LTD, Huizhou (CN)

(72) Inventor: Qiuming LIU, Huizhou (CN)

(21) Appl. No.: 14/789,202

(22) Filed: Jul. 1, 2015

Related U.S. Application Data
(63) Continuation of application No. PCT/CN2014/084250, filed on Aug. 13, 2014.

(51) Int. Cl. A24F 47/00; H05B 1/02; H05B 3/44; F22B 1/28

(52) U.S. Cl. CPC A24F 47/008; F22B 1/284; H05B 1/0297; H05B 3/44

(57) ABSTRACT

An atomizer and an electronic cigarette are provided according to the present application. The atomizer includes an atomizing sleeve, and a cylindrical liquid storage member and an atomizing assembly are arranged in the atomizing sleeve. The atomizing assembly is arranged to be electrically connected to an atomizer electrode, and the atomizing assembly includes an electric heating wire and a liquid guiding member. A smoke passage allowing the smoke to flow is arranged in an axial direction of the cylindrical liquid storage member and runs through the cylindrical liquid storage member, and the cylindrical liquid storage member is provided with a guide groove. Due to the guide groove arranged on the cylindrical liquid storage member in the present application, the atomizing assembly may be guided by the guide groove to be directly assembled into the cylindrical liquid storage member when assembling the atomizer.

### CROSS-REFERENCE TO RELATED APPLICATIONS

This application is a continuation of International Application No. PCT/CN2014/084250, titled “ATOMIZER AND ELECTRONIC CIGARETTE”, filed on Aug. 13, 2014, the entire disclose of which is incorporated herein by this reference.

### TECHNICAL FIELD

The present application relates to the field of electronic cigarettes, and particularly to an atomizer and an electronic cigarette which are easy to be assembled by automated equipment.

### BACKGROUND

The structure of an atomizer in the conventional technology is described in conjunction with FIG. 1. As illustrated in FIG. 1, the atomizer in the conventional technology includes an electric heating assembly 100 and a liquid storage cotton 101 covering the electric heating assembly 100. The electric heating assembly 100 is fixed to an air pipe 102, the air pipe 102 is fixedly sleeved on a fixing seat 103, the liquid storage cotton 101 is configured to store cigarette liquid and transfer the stored cigarette liquid to the electric heating assembly 100, and the electric heating assembly 100 is configured to atomize the cigarette liquid to generate smoke for users to smoke.

In the conventional technology, the liquid storage cotton 101 is a sheet structure, and when assembling the atomizer, it is required to manually roll the liquid storage cotton 101 of the sheet structure into a barrel shape to cover the electric heating assembly 100, thus the head ant the tail of the liquid storage cotton 101 of the sheet structure are staggered and arranged at its own inner side and outer side. In assembling, the electric heating assembly 100 is fixed to the air pipe 102 firstly, and then the sheet liquid storage cotton 101 is covered on the air pipe 102 and the electric heating assembly 100, and finally the air pipe 102 covered with the liquid storage cotton 101 is fixedly sleeved on the fixing seat 103.

Processing the liquid storage cotton 101 manually has a relatively low efficiency, thus does not meet the requirement for the production efficiency of electronic cigarettes of the manufacturers, and the cost for producing the electronic cigarettes is high, and manual operation has a low accuracy. If the depth of the electric heating assembly 100 being inserted into the liquid storage cotton 101 does not meet the requirement, it is apt to cause that the electric heating assembly 100 cannot obtain sufficient cigarette liquid in the actual use of the atomizer, and then the atomized smoke does not meet the requirement of the user, which reduces the user experience. Furthermore, the assembled structure is unstable, the electric heating assembly 100 is easy to be detached from the liquid storage cotton 101, which affects the service life of the electronic cigarette. And the liquid storage cotton 101 is apt to be contaminated during manually rolling the liquid storage cotton 101, thus the sanitary situation of the assembled liquid storage cotton 101 does not meet the requirement.

### SUMMARY

An atomizer and an electronic cigarette are provided according to the present application, which are easy to be assembled by automated equipment.

An atomizer configured to form an electronic cigarette in combination with a battery rod assembly is provided, wherein the atomizer includes an atomizing sleeve, a cylindrical liquid storage member made of a liquid absorbing material and an atomizing assembly configured to atomize cigarette liquid to form smoke are arranged in the atomizing sleeve, and an atomizer electrode configured to be electrically connected to the battery rod assembly is connected to one end of the atomizing sleeve.

The atomizing assembly is arranged to be electrically connected to the atomizer electrode, and the atomizing assembly includes an electric heating wire for atomizing the cigarette liquid and a liquid guiding member for delivering the cigarette liquid stored in the cylindrical liquid storage member to the electrical heating wire to be atomized, and the electrical heating wire is wound around the liquid guiding member.

A smoke passage allowing the smoke to flow is arranged in an axial direction of the cylindrical liquid storage member and runs through the cylindrical liquid storage member, the cylindrical liquid storage member is provided with a guide groove, the guide groove is in communication with the smoke passage and an outer surface of the cylindrical liquid storage member. The guide groove is configured to guide the atomizing assembly to be inserted into the cylindrical liquid storage member when assembling the atomizer, and to allow the electric heating wire wound around the liquid guiding member to be located inside the smoke passage.

In the atomizer, an end, corresponding to the atomizer electrode, of the cylindrical liquid storage member is provided with two first guide grooves opposite to each other, the two first guide grooves are respectively located at opposite sides of the smoke passage, and a guiding direction of each of the first guide grooves is parallel to the axial direction of the atomizer.

The first guide grooves are configured to guide the atomizing assembly to be inserted into the cylindrical liquid storage member when assembling the atomizer, to allow the electric heating wire wound around the liquid guiding member to be located inside the smoke passage, and two ends of the liquid guiding member are respectively located in the two first guide grooves.

In the atomizer, the longitudinal section of each of the first guide grooves is n-shaped, rectangular or irregular.

In the atomizer, an end, corresponding to the atomizer electrode, of the cylindrical liquid storage member is provided with a second guide groove, the second guide groove is located at one side of the smoke passage; a first preset angle is formed between a guiding direction of the second guide groove and the axial direction of the atomizer, and the first preset angle is greater than 0 degree and less than or equal to 90 degrees.

The second guide groove is configured to guide the atomizing assembly to be inserted into the cylindrical liquid storage member when assembling the atomizer, and to allow the electric heating wire wound around the liquid guiding member to be located inside the smoke passage.

In the atomizer, an end, adjacent to the smoke passage, of the first guide groove or the second guide groove is formed with an accommodating space having a shape matching with the shape of the atomizing assembly and configured to fix the atomizing assembly.

In the atomizer, the cylindrical liquid storage member includes a first cylindrical liquid storage sub-member and a second cylindrical liquid storage sub-member, and the first cylindrical liquid storage sub-member and the second cylindrical liquid storage sub-member are coaxially arranged in the axial direction of the atomizer, and are sequentially arranged in a direction towards the atomizer electrode.

The atomizing assembly is located between the first cylindrical liquid storage sub-member and the second cylindrical liquid storage sub-member, and the electric heating wire wound around the liquid guiding member is located inside the smoke passage.

Two ends of the liquid guiding member are extended to be inserted into the second cylindrical liquid storage sub-member, to allow the two ends of the liquid guiding member which are located inside the second cylindrical liquid storage sub-member to be located at two sides of the smoke passage.

In the atomizer, the second cylindrical liquid storage sub-member is provided with two third guide grooves, and the two third guide grooves are respectively located at two sides of the smoke passage.

A second preset angle is formed between a guiding direction of the third guide groove and the axial direction of the atomizer, and the second preset angle is greater than or equal to 0 degree and less than 90 degrees.

The third guide groove is configured to guide two ends of the liquid guiding member to be inserted into the second cylindrical liquid storage sub-member when assembling the atomizer.

In the atomizer, an outer peripheral surface of the cylindrical liquid storage member is provided with an adhesion layer.

In the atomizer, a glass fiber tube is inserted in the cylindrical liquid storage member, and the smoke passage is located in a hollow portion of the glass fiber tube.

The atomizer further includes a mounting bracket located between the atomizing assembly and the atomizer electrode and made of conductive material.

A first end of the mounting bracket is electrically connected to an end of the electric heating wire and a second end of the mounting bracket is electrically connected to the atomizer electrode, to allow the atomizer electrode to be electrically connected to the electric heating wire via the mounting bracket.

In the atomizer, the atomizer electrode includes an outer electrode, an inner electrode inserted in the outer electrode, and an insulating ring arranged between the outer electrode and the inner electrode. The atomizer further includes an atomizing seat, and two fourth guide groove are provided and run through the atomizing seat, the fourth guide grooves are configured to allow the second end of the mounting bracket to pass through the fourth guide groove when assembling the atomizer, to enable the second end of the mounting bracket passing through the fourth guide grooves to be electrically connected to the outer electrode and the inner electrode, respectively.

A first through hole is provided and runs through the atomizing seat, and the first through hole is arranged coaxially with the smoke passage, and the first through hole is in communication with the smoke passage, to allow airflow entered from an end of the atomizer to flow into the smoke passage via the first through hole.

In the atomizer, a suction nozzle cover is arranged at an end of the atomizing sleeve away from the atomizer electrode, and the smoke atomized by the electric heating wire is configured to be delivered to the suction nozzle cover via the smoke passage.

The suction nozzle cover is provided with at least one air hole in communication with the smoke passage, to enable a user to inhale the smoke through the air hole.

A sealing ring for sealing the cigarette liquid stored in the cylindrical liquid storage member is arranged between the suction nozzle cover and the cylindrical liquid storage member, the sealing ring is provided with a second through hole, and the second through hole is arranged at a position corresponding to the smoke passage, to allow the air hole of the suction nozzle cover to be in communication with the smoke passage through the second through hole.

The outer electrode is provided with an intake passage, and two ends of the intake passage are respectively provided with an air inlet for allowing airflow outside the atomizer to flow into the intake passage and an air outlet for allowing airflow inside the intake passage to flow into the atomizer.

An included angle less than 90 degree is formed between an extending direction of the intake passage and the axial direction of the atomizer, a distance between the air inlet and the electric heating wire is greater than a distance between the air outlet and the electric heating wire, and the intake passage is in communication with the smoke passage through the first through hole.

In the atomizer, the mounting bracket includes two support columns arranged in parallel and spaced apart from each other, a first end of each of the support columns is provided with an insertion hole, to allow a respective end of the electric heating wire to be inserted in the insertion hole.

A portion of the electric heating wire inside the insertion hole is fixedly connected to the first end of the support column by welding or riveting.

In the atomizer, the mounting bracket includes two support columns arranged in parallel and spaced apart from each other, a first end of each of the support columns is arranged in parallel with a respective end of the electric heating wire in a radial direction of the atomizer.

The respective end of the electric heating wire is fixedly connected to the first end of the support column by welding or riveting.

In the atomizer, the mounting bracket includes two support columns arranged in parallel and spaced apart from each other, a first end of each of the support columns is provided with an arc-shaped section having an arc-shaped cross-section, and the arc-shaped section include an inward recessed portion.

The inward recessed portion of the arc-shaped section faces a respective end of the electric heating wire, and the inward recessed portion of the arc-shaped section is arranged in parallel with the end of the electric heating wire in a radial direction of the atomizer.

The respective end of the electric heating wire is fixedly connected to the inward recessed portion of the arc-shaped section by welding or riveting.

In the atomizer, the cylindrical liquid storage member is formed by a solid polyhedron provided with the smoke passage and the guide groove, or a rotating body provided with the smoke passage and the guide groove, or a hollow cylinder provided with the guide groove in communication with a hollow portion of the hollow cylinder, or the cylindrical liquid storage member is integrally formed.

An electronic cigarette includes an atomizer and a battery rod assembly for supplying power to the atomizer, and the atomizer is arranged coaxially with the battery rod assembly, wherein the atomizer includes an atomizing sleeve, a cylindrical liquid storage member made of a liquid absorbing material and an atomizing assembly configured to atomize cigarette liquid to form smoke are arranged in the atomizing sleeve.

The atomizing assembly includes an electric heating wire for atomizing the cigarette liquid and a liquid guiding member for delivering the cigarette liquid stored in the cylindrical liquid storage member to the electrical heating wire to be atomized, and the electrical heating wire is wound around the liquid guiding member.

A smoke passage allowing the smoke to flow is arranged in an axial direction of the cylindrical liquid storage member and runs through the cylindrical liquid storage member, the cylindrical liquid storage member is provided with a guide groove, the guide groove is in communication with the smoke passage and an outer surface of the cylindrical liquid storage member, and the guide groove is configured to guide the atomizing assembly to be inserted into the cylindrical liquid storage member when assembling the atomizer, and to allow the electric heating wire wound around the liquid guiding member to be located inside the smoke passage.

The present application provides an atomizer and an electronic cigarette. The atomizer includes an atomizing sleeve, and a cylindrical liquid storage member and an atomizing assembly are arranged in the atomizing sleeve. The atomizing assembly is arranged to be electrically connected to an atomizer electrode. The atomizing assembly includes an electric heating wire for atomizing the cigarette liquid and a liquid guiding member for delivering the cigarette liquid stored in the cylindrical liquid storage member to the electrical heating wire to be atomized, and the electrical heating wire is wound around the liquid guiding member. A smoke passage allowing the smoke to flow is arranged in an axial direction of the cylindrical liquid storage member and runs through the cylindrical liquid storage member, the cylindrical liquid storage member is provided with a guide groove, and the guide groove is configured to guide the atomizing assembly to be inserted into the cylindrical liquid storage member when assembling the atomizer, and to allow the electric heating wire wound around the liquid guiding member to be located inside the smoke passage. Due to the guide groove arranged on the cylindrical liquid storage member in the present application, the atomizing assembly may be guided by the guide groove to be directly assembled into the cylindrical liquid storage member when assembling the atomizer, thereby improving the stability of the structure of the atomizer, obtaining a better liquid guiding effect and facilitating assembling the atomizer by automated equipment to improve the assembling efficiency, and avoiding the problems caused by manual assembly in the conventional technology that the assembly is not in place, the structure is unreliable, and it is apt to be contaminated and has a low assembling efficiency.

### BRIEF DESCRIPTION OF THE DRAWINGS

FIG. 1 is a schematic view showing the sectional structure of an atomizer according to the conventional technology;

FIG. 2 is a schematic view showing the overall structure of a preferred embodiment of an atomizer according to embodiments of the present application;

FIG. 3 is a schematic view showing the sectional structure of a preferred embodiment of the atomizer according to embodiments of the present application;

FIG. 4 is a partial exploded schematic view of a preferred embodiment of the atomizer according to embodiments of the present application;

FIG. 5 is a schematic view showing the partial structure of a preferred embodiment of the atomizer according to embodiments of the present application;

FIG. 6 is a schematic view showing the overall structure of a preferred embodiment of a cylindrical liquid storage member according to embodiments of the present application;

FIG. 7 is a schematic view showing the overall structure of another preferred embodiment of the cylindrical liquid storage member according to embodiments of the present application;

FIG. 8 is a schematic view showing the overall structure of another preferred embodiment of the cylindrical liquid storage member according to embodiments of the present application;

FIG. 9 is a schematic view showing the sectional structure of another preferred embodiment of the atomizer according to embodiments of the present application;

FIG. 10 is a schematic view showing the sectional structure of another preferred embodiment of the atomizer according to embodiments of the present application;

FIG. 11 is a schematic view showing the partial structure of another preferred embodiment of the atomizer according to embodiments of the present application;

FIG. 12 is a schematic view showing the partial structure of another preferred embodiment of the atomizer according to embodiments of the present application;

FIG. 13 is a partial exploded schematic view of another preferred embodiment of the atomizer according to embodiments of the present application;

FIG. 14 is a schematic view showing the structure of a preferred embodiment of a suction nozzle cover according to embodiments of the present application; and

FIG. 15 is a schematic view showing the sectional structure of a preferred embodiment of an electronic cigarette according to embodiments of the present application.

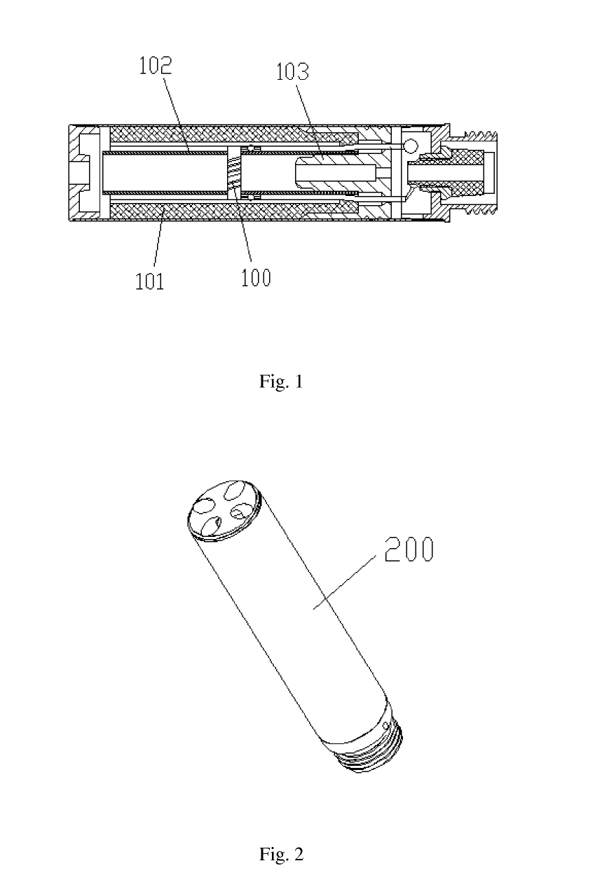

### DETAILED DESCRIPTION

In a first embodiment, the specific structure of an atomizer is described in detail, and the atomizer is easy to be assembled by automated equipment.

The overall structure of the atomizer in this embodiment is shown in FIG. 2, wherein FIG. 2 is a schematic view showing the overall structure of a preferred embodiment of the atomizer according to the present application.

The atomizer shown in FIG. 2 is connected to a battery rod assembly to form an electronic cigarette. The battery rod assembly is configured to supply power to the atomizer, to allow the atomizer to atomize the cigarette liquid to form smoke.

The atomizer includes an atomizing sleeve 200.

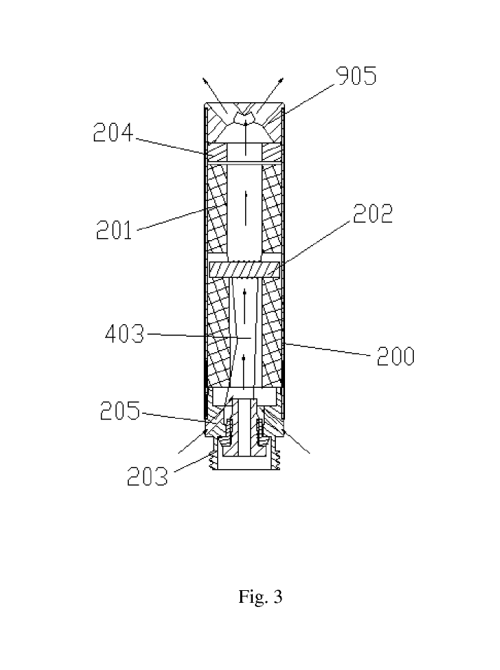

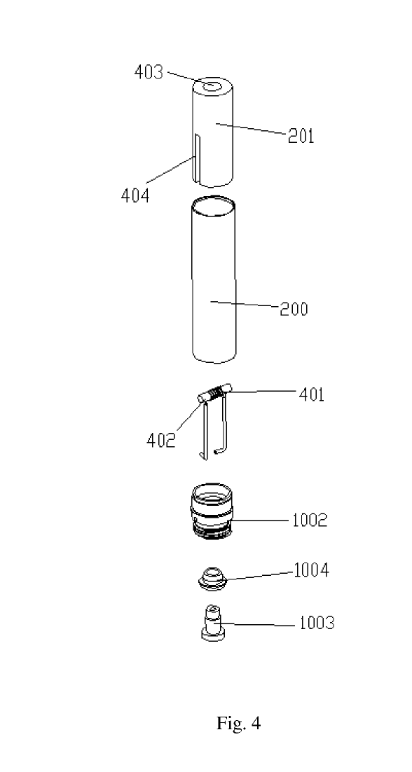

The specific structure of the interior of the atomizing sleeve 200 is shown in FIGS. 3 and 4, wherein FIG. 3 is a schematic view showing the sectional structure of a preferred embodiment of the atomizer according to the present application; and FIG. 4 is an exploded schematic view showing the structure of a preferred embodiment of the atomizer according to the present application.

A cylindrical liquid storage member 201 made of liquid-absorbing material is provided inside the atomizing sleeve 200.

The specific material of the cylindrical liquid storage member 201 is not limited in this embodiment as long as it can store the cigarette liquid, for example, sponge, fiber or composite material formed by the fiber mixture and etc.

The cylindrical liquid storage member 201 is configured to store the cigarette liquid.

As shown in FIG. 3, an atomizing assembly 202 for atomizing the cigarette liquid to form smoke is further provided inside the atomizing sleeve 200.

In this embodiment, the atomizing assembly 202 is configured to atomize the cigarette liquid stored in the cylindrical liquid storage member 201 to generate smoke for users to smoke.

An atomizer electrode 203 configured to be electrically connected to the battery rod assembly is connected to one end of the atomizing sleeve 200.

That is, in practical application, the battery rod assembly supplies power to the atomizing assembly 202 through the atomizer electrode 203, to allow the atomizing assembly 202 to atomize the cigarette liquid.

The manner of providing the atomizer electrode 203 on one end of the atomizing sleeve 200 is not limited in this embodiment. For example, the atomizer electrode 203 may be fixedly arranged on one end of the atomizing sleeve 200, and the atomizer electrode 203 may also be detachably inserted into one end of the atomizing sleeve 200. The detachable connection may be implemented as follows, one end of the atomizing sleeve 200 is provided with a threaded section and an outer peripheral surface of the atomizer electrode 203 is also provided with a threaded section, thus the atomizer electrode 203 can be screwed onto one end of the atomizing sleeve 200 by the threaded sections. Of course, other detachable connections may also be adopted, such as snap fit, magnet attraction and etc., and the specific manner is not limited in this embodiment.

To allow the battery rod to supply power to the atomizing assembly 202, the atomizing assembly 202 is electrically connected to the atomizer electrode 203.

The specific structure of the atomizing assembly 202 is described hereinafter with reference to FIG. 4.

The atomizing assembly 202 includes an electric heating wire 401 and a liquid guiding member 402.

The electric heating wire 401 is configured to atomize the cigarette liquid.

The liquid guiding member 402 for delivering the cigarette liquid stored in the cylindrical liquid storage member 201 to the electric heating wire 401.

The electric heating wire 401 is wound around the liquid guiding member 402, thus the liquid guiding member 402 can deliver the cigarette liquid to the electric heating wire 401.

The material of the liquid guiding member 402 is not limited in this embodiment as long as it can deliver the cigarette liquid to the electric heating wire 401. Specifically, this embodiment is illustrated by taking the liquid guiding member 402 made of glass fiber material as an example.

To facilitate the flow of the smoke, a smoke passage 403 allowing the smoke to flow is arranged in an axial direction of the cylindrical liquid storage member 201 and runs through the cylindrical liquid storage member 201. The electric heating wire 401 is located inside the smoke passage 403, thus the smoke generated by the electric heating wire 401 atomizing the cigarette liquid can flow inside the smoke passage 403, and the specific flow direction is indicated by the arrow shown in FIG. 3.

In order to facilitate assembling the atomizer, the cylindrical liquid storage member 201 is provided with a guide groove 404. The guide groove 404 is in communication with the smoke passage 403 and the outer surface of the cylindrical liquid storage member 201, and the guide groove 404 is configured to guide the atomizing assembly 202 to be inserted into the cylindrical liquid storage member 201 when assembling the atomizer, and to allow the electric heating wire 401 wound around the liquid guiding member 402 to be located inside the smoke passage 403.

The cylindrical liquid storage member 201 may be formed by a solid polyhedron or a rotating body provided with the smoke passage 403 and the guide groove 404, or formed by a hollow cylinder provided with the guide groove 404 in communication with the hollow portion. Or the cylindrical liquid storage member 201 is an integrally formed structure, and this structure can effectively guarantee that the formed cylindrical liquid storage member 201 have a stable structure and a good strength, and can effectively guarantee that the atomizer can be easily gripped when being assembled by the automated equipment, and can ensure that the cylindrical liquid storage member 201 will not be deformed in use, which allows the cylindrical liquid storage member 201 to provide the cigarette liquid stably and uniformly.

When assembling the atomizer, since the cylindrical liquid storage member 201 is configured to have the above structure, there is no need to manually roll the liquid storage cotton into a cylindrical shape as in the conventional technology, and it is simply required to provide the guide groove 404 on the cylindrical liquid storage member 201, to allow the liquid guiding member 402 to be guided by the guide groove 404 to be inserted into the cylindrical liquid storage member 201, thereby effectively reducing the operational steps and improving the assembling efficiency of the atomizer, and allowing the assembled atomizer to have a stable structure. Further, the depth of the liquid guiding member 402 being inserted into the cylindrical liquid storage member 201 after the liquid guiding member 402 is assembled satisfies the requirement, thereby guaranteeing that the cylindrical liquid storage member 201 can provide an adequate and stable cigarette liquid to the electric heating wire 401, and guaranteeing the concentration of smoke.

In a second embodiment, the specific structure of the guide groove is described in detail.

It should be noted that, the guide groove in this embodiment is described as an example and does not intend to constitute to form a limitation.

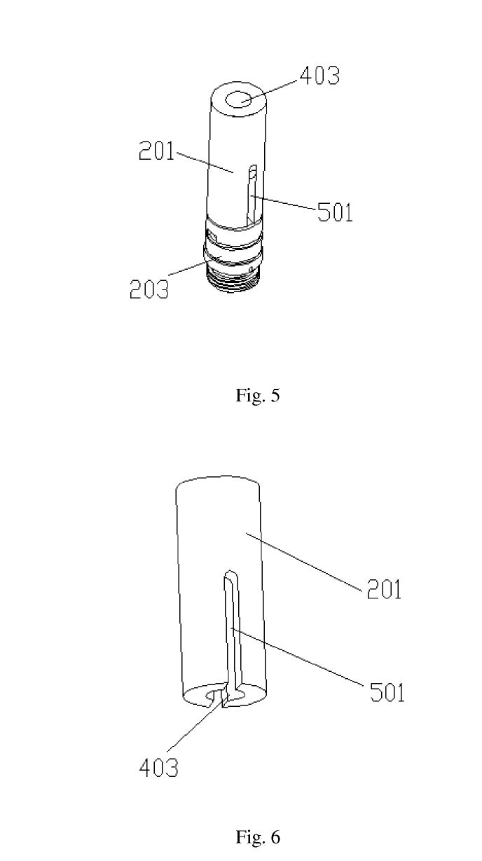

A first arrangement of the guide groove is described hereinafter in conjunction with FIGS. 5 and 6.

An end, corresponding to the atomizer electrode 203, of the cylindrical liquid storage member 201 is provided with two first guide grooves 501 opposite to each other. The two first guide grooves 501 are respectively located at opposite sides of the smoke passage 403, and the guiding direction of each of the first guide grooves 501 is parallel to an axial direction of the atomizer. Two ends of the liquid guiding member 402 are respectively located in the two first guide grooves 501.

The first guide grooves 501 are configured to guide the atomizing assembly 202 into the cylindrical liquid storage member 201 when assembling the atomizer, and to allow the electric heating wire 401 wound around the liquid guiding member 402 to be located inside the smoke passage 403, as shown in FIG. 3.

Preferably, the longitudinal section of the first guide groove 501 in this embodiment is n-shaped, of course, the specific shape of the first guide groove 501 is not limited in this embodiment as long as the liquid guiding member 402 can be guided by the first guide groove 501 to move into the cylindrical liquid storage member 201, for example, the longitudinal section of the first guide groove may also be of a rectangular shape or irregular shape.

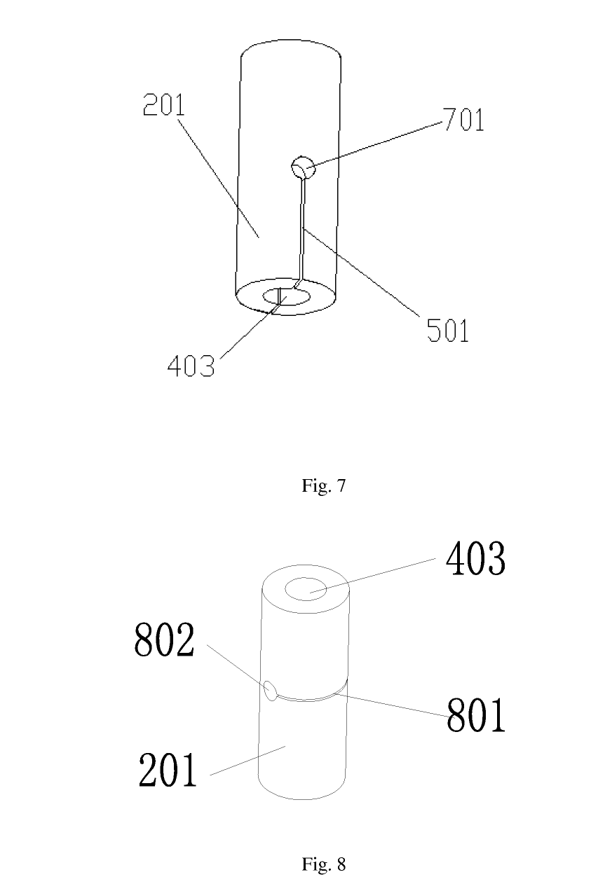

Preferably, as shown in FIG. 7, an end, adjacent to the smoke passage 403, of the first guide groove 501 is provided with an accommodating space 701 having a shape matching with the shape of the atomizing assembly 202 and configured to fix the atomizing assembly 202. The cylindrical liquid storage member 201 can better fix the atomizing assembly 202 through the accommodating space 701, which enables the assembled atomizer to have a more stable structure.

Further, the longitudinal section of the accommodating space 701 may be circular or arc-shaped, and etc., and the special shape is not limited as long as the accommodating space 701 can stably fix the atomizing assembly 202.

A second arrangement of the guide groove is described in detail hereinafter in conjunction with FIG. 8.

The end, corresponding to the atomizer electrode, of the cylindrical liquid storage member 201 is provided with a second guide groove 801, and the second guide groove 801 is located at one side of the smoke passage 403.

A first preset angle is formed between the guiding direction of the second guide groove 801 and the axial direction of the atomizer, and the first preset angle is greater than 0 degree and less than or equal to 90 degrees.

As shown in FIG. 8, the first preset angle being 90 degrees is described as an example in this embodiment.

The second guide groove 801 is configured to guide the atomizing assembly 202 to be inserted into the cylindrical liquid storage member 201 when assembling the atomizer, and to allow the electric heating wire 401 wound around the liquid guiding member 402 to be located inside the smoke passage 403.

Preferably, as shown in FIG. 8, the end, adjacent to the smoke passage 403, of the second guide groove 801 is provided with an accommodating space 802 having a shape matching with the shape of the atomizing assembly 202 and configured to fix the atomizing assembly 202. The cylindrical liquid storage member 201 can better fix the atomizing assembly 202 through the accommodating space 802, which enables the assembled atomizer to have a more stable structure.

Further, the longitudinal section of the accommodating space 802 may be circular or arc-shaped, and etc., and the specific shape is not limited as long as the accommodating space 802 can stably fix the atomizing assembly 202.

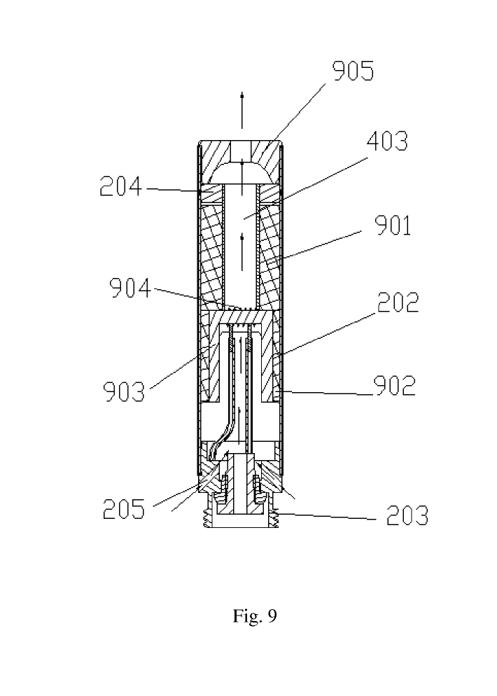

A third arrangement of the guide groove is described in detail hereinafter in conjunction with FIG. 9.

The cylindrical liquid storage member includes: a first cylindrical liquid storage sub-member 901 and a second cylindrical liquid storage sub-member 902, i.e., the first cylindrical liquid storage sub-member 901 and the second cylindrical liquid storage sub-member 902 are combined to form the cylindrical liquid storage member.

One combination manner is described as follows. The first cylindrical liquid storage sub-member 901 and the second cylindrical liquid storage sub-member 902 are coaxially arranged in the axial direction of the atomizer, and the first cylindrical liquid storage sub-member 901 and the second cylindrical liquid storage sub-member 902 are sequentially arranged in a direction towards the atomizer electrode 203.

The atomizing assembly 202 is located between the first cylindrical liquid storage sub-member 901 and the second cylindrical liquid storage sub-member 902, that is, the atomizing assembly 202 is clamped between the first cylindrical liquid storage sub-member 901 and the second cylindrical liquid storage sub-member 902.

In order to facilitate the smooth flow of the smoke, the electric heating wire wound around the liquid guiding member is located inside the smoke passage 403.

Preferably, for further enhancing the connection stability between the atomizing assembly 202 and the cylindrical liquid storage member, in this embodiment, two ends of the liquid guiding member 903 extend to be inserted into the second cylindrical liquid storage sub-member 902, thus the two ends of the liquid guiding member 903 which are located inside the second cylindrical liquid storage sub-member 902 are respectively located at two sides of the smoke passage 403.

The arrangement shown in FIG. 9 has advantages that, due to the gravity, a part of the cigarette liquid stored in the cylindrical liquid storage member may be converged into the end of the second cylindrical liquid storage sub-member 902 near the atomizer electrode 203, and since two ends of the liquid guiding member 903 in this embodiment are inserted to the bottom of the second cylindrical liquid storage sub-member 902, a sufficient amount of cigarette liquid can be delivered to the electric heating wire 904.

And since the liquid guiding member 903 in this embodiment is clamped between the first cylindrical liquid storage sub-member 901 and the second cylindrical liquid storage sub-member 902 and two ends of the liquid guiding member 903 are inserted into the second cylindrical liquid storage sub-member 902, the connection between the atomizing assembly 202 and the cylindrical liquid storage member is more stable.

Preferably, for facilitate assembling the atomizer, i.e., enabling the first cylindrical liquid storage sub-member 901 and the second cylindrical liquid storage sub-member 902 to clamp the atomizing assembly 202 quickly, the second cylindrical liquid storage sub-member 902 is provided with two third guide grooves, and the third guide grooves are respectively located at two sides of the smoke passage 403.

A second preset angle is formed between the guiding direction of the third guide groove and the axial direction of the atomizer, and the second preset angle is greater than or equal to 0 degree and less than 90 degrees.

The second preset angle being 0 degree is described as an example in this embodiment.

The third guide groove is configured to allow two ends of the liquid guiding member 903 to be guided by the third guide grooves to be inserted into the second cylindrical liquid storage sub-member 902 when assembling the atomizer.

Due to the third guide grooves, two ends of the liquid guiding member 903 can be quickly positioned and inserted into the second cylindrical liquid storage sub-member 902 when assembling the atomizer, and the third guide grooves may ensure that two ends of the liquid guiding member 903 can be inserted to the bottom of the second cylindrical liquid storage sub-member 902, thus a sufficient amount of the cigarette liquid inside the second cylindrical liquid storage sub-member 902 can be obtained by the liquid guiding member 903, and the stable output of the smoke and the smoke concentration are ensured, which meets the requirement for the smoke concentration of the user.

In a third embodiment, a structure to improve the stability of the atomizer is described.

For improving the stability of the atomizer, the following means are employed in this embodiment.

First, the outer peripheral surface of the cylindrical liquid storage member 201 is provided with an adhesion layer.

The manner of providing the adhesion layer on the outer peripheral surface of the cylindrical liquid storage member 201 is not limited in this embodiment, for example, an adhesive layer with a thickness meeting the thickness requirement may be coated on the outer peripheral surface of the liquid storage member and then are dried, to form the adhesion layer.

The advantage of providing the adhesion layer on the cylindrical liquid storage member 201 is that the stability of the cylindrical liquid storage member 201 can be further improved, and it can also avoid the defect that the assembling efficiency of the atomizer is reduced since the soft liquid storage member is not easy to assemble.

Preferably, a glass fiber tube may be further inserted in the cylindrical liquid storage member 201, and the smoke passage 403 is located in a hollow portion of the glass fiber tube.

The glass fiber tube in this embodiment is embodied as an insulating sleeve, which is woven by alkali-free glass fiber, then coated with polyvinyl chloride resin and then are heated to be plasticized, thus it can resist a high temperature and will not accumulate the cigarette liquid.

The advantage of using the glass fiber tube is that it can effectively prevent excessive cigarette liquid being stored in the cylindrical liquid storage member 201 which may block the smoke passage 403 and further affect the normal operation of the electronic cigarette.

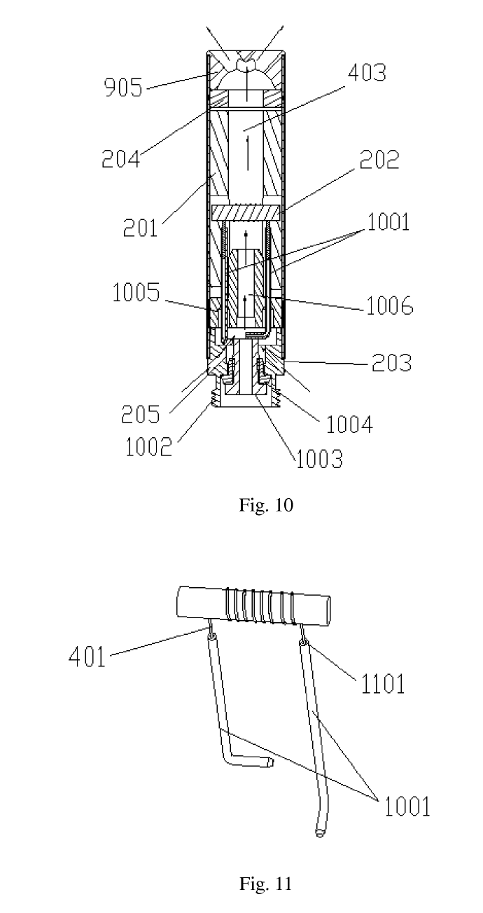

To further improve the assembling efficiency of the atomizer and further improve the stability of the atomizer, as shown in FIG. 10, the atomizer further includes a mounting bracket 1001 located between the atomizing assembly 202 and the atomizer electrode 203 and made of conductive material.

A first end of the mounting bracket 1001 is electrically connected to an end of the electric heating wire, and a second end of the mounting bracket 1001 is electrically connected to the atomizer electrode 203, thus the atomizer electrode 203 is electrically connected to the electric heating wire via the mounting bracket 1001.

The specific structure of the mounting bracket 1001 is described in detail hereinafter.

First, referring to FIG. 11, the mounting bracket 1001 includes two support columns arranged in parallel and spaced apart from each other. A first end of each of the support columns is provided with an insertion hole 1101. The ends of the electric heating wire 401 may be inserted into the insertion holes 1101.

A part of the electric heating wire 401 inserted into the insertion hole 1101 is fixedly connected to the first end of the mounting bracket 1001 by welding or riveting.

The welding or riveting is the conventional technology, and the manner to achieve welding or riveting will not be described in detail in this embodiment.

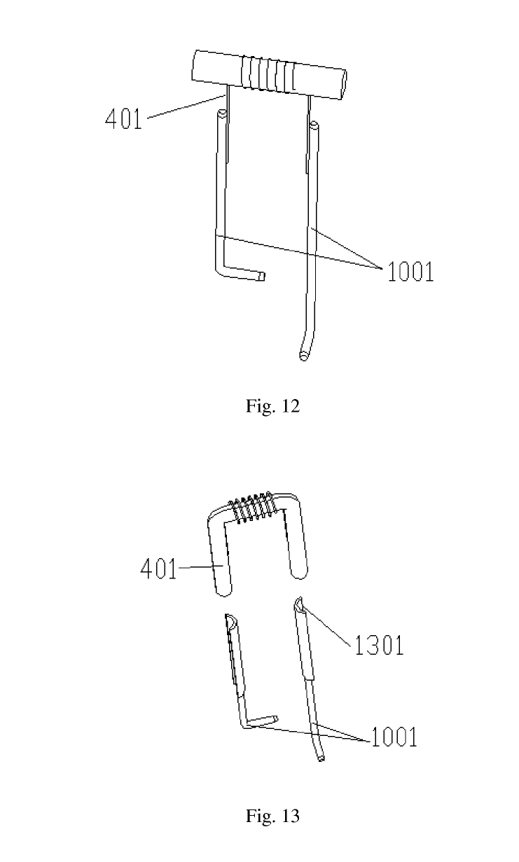

Reference is also made to FIG. 12. The mounting bracket 1001 includes two support columns arranged in parallel and spaced apart from each other. A first end of each of the support columns is arranged in parallel with the respective end of the electric heating wire 401 in the radial direction of the atomizer.

The ends of the electric heating wire 401 are fixedly connected to the first ends of the mounting bracket 1001 respectively by welding or riveting.

Reference is also made to FIG. 13. The mounting bracket 1001 includes two support columns arranged in parallel and spaced apart from each other. A first end of each of the support columns is provided with an arc-shaped section 1301 having an arc-shaped cross section, and the arc-shaped section 1301 includes an inward recessed portion.

The manner for forming the arc-shaped section 1301 is not limited in this embodiment as long as the arc-shaped section 1301 can be formed, for example, the first end of the mounting bracket 1001 may be pressed into sheet, and a first end of the sheet mounting bracket 1001 is bent to form the arc-shaped section 1301.

Further, the inward recessed portion of the arc-shaped section 1301 faces the respective end of the electric heating wire 401. The inward recessed portion of the arc-shaped section 1301 is arranged in parallel with the end of the electric heating wire 401 in the radial direction of the atomizer.

The end of the electric heating wire 401 is fixedly connected to the inward recessed portion of the arc-shaped section 1301 by welding or riveting.

Since the mounting bracket 1001 in this embodiment is made of a rigid and conductive material, the structure of the assembled atomizer is more stable, and the assembling efficiency of the atomizer is effectively improved.

More preferably, as shown in FIG. 10, the electrical connection structure of the interior of the atomizer is described in detail.

The atomizer electrode 203 includes an outer electrode 1002, an inner electrode 1003 inserted in the outer electrode 1002, and an insulating ring 1004 arranged between the outer electrode 1002 and the inner electrode 1003.

The exploded view showing the connection structure of the atomizer electrode 203 may be referred to FIG. 4.

The atomizer further includes an atomizing seat 1005. The atomizing seat 1005 is provided with two fourth guide grooves which run through the atomizing seat 1005. The fourth guide grooves are configured to allow the second ends of the mounting bracket 1001 to pass through the fourth guide grooves respectively when assembling the atomizer, to allow the second ends of the mounting bracket 1001 passing through the fourth guide grooves to be electrically connected to the outer electrode 1002 and the inner electrode 1004 respectively.

The atomizing seat 1005 can better fix the mounting bracket 1001, and then under the combined action of the atomizing seat 1005 and the mounting bracket 1001, the cylindrical liquid storage member 201 can be better fixed by the atomizer, and the atomizer can be more easily assembled by users, thereby improving the efficiency of assembling the atomizer and facilitating mass automated production of the atomizer.

To facilitate the flow of the smoke, a first through hole 1006 is provided and runs through the atomizing seat 1005, and the first through hole 1006 is arranged coaxially with the smoke passage 403, thus the first through hole 1006 is in communication with the smoke passage 403. The flow direction of the smoke may be referred to the direction indicated by the arrow shown in FIG. 10.

Further, as shown in FIGS. 9 and 10, a suction nozzle cover 905 is arranged at an end of the atomizing sleeve away from the atomizer electrode 203, thus the user can inhale the smoke through the suction nozzle cover 905.

Further, the smoke atomized by the electric heating wire may flow to the suction nozzle cover 905 through the smoke passage 403.

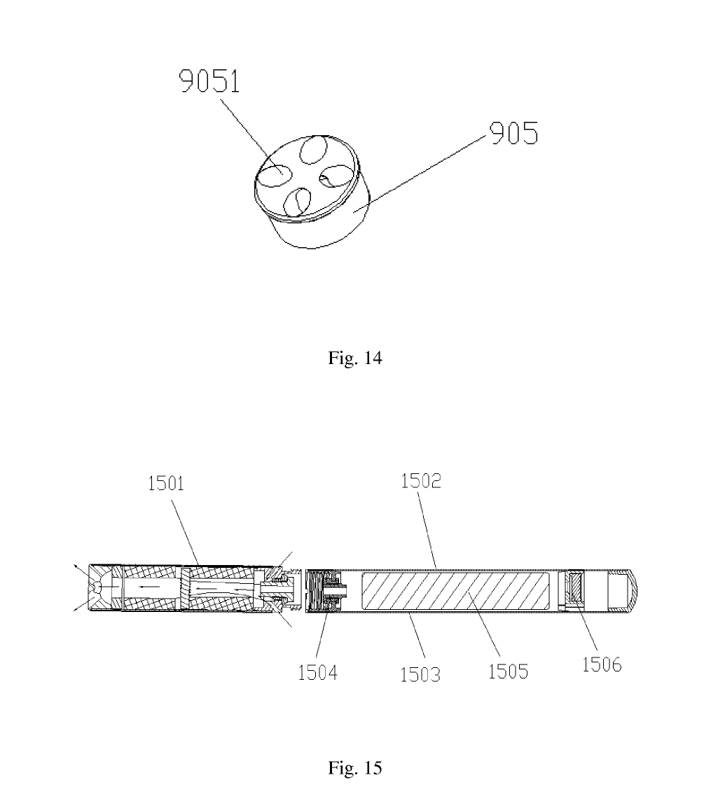

As shown in FIG. 14, the suction nozzle cover 905 is provided with at least one air hole 9051 in communication with the smoke passage 403, to allow the user to inhale the smoke through the air hole 9051.

To ensure the smooth flow of the smoke, the suction nozzle cover 905 may be provided with only one air hole 9051 with a large diameter.

To prevent the situation that the user cannot smoke normally when the air hole 9051 is blocked, the suction nozzle cover 905 may be provided with multiple air holes 9051, as shown in FIG. 14.

The size and number of the air hole 9051 are not limited in this embodiment as long as the air hole 9051 is in communication with the smoke passage 403.

Reference is made to FIGS. 3, 9 and 10, a sealing ring 204 is arranged between the suction nozzle cover 905 and the cylindrical liquid storage member 201 and is configured to seal the cigarette liquid stored in the cylindrical liquid storage member 201. The sealing ring 204 is provided with a second through hole, and the second through hole is arranged at a position corresponding to the smoke passage 403, thus the air hole 9051 of the suction nozzle cover 905 is in communication with the smoke passage 403 through the second through hole.

To enable the airflow outside the atomizer to flow into the atomizer, the outer electrode 1002 is provided with an intake passage 205.

Further, two ends of the intake passage 205 are respectively provided with an air inlet for allowing the airflow outside the atomizer to flow into the intake passage 205 and an air outlet for allowing the airflow inside the intake passage 205 to flow into the atomizer.

An included angle less than 90 degrees is formed between the extending direction of the intake passage 205 and the axial direction of the atomizer, and the distance between the air inlet and the electric heating wire is greater than the distance between the air outlet and the electric heating wire. The intake passage 205 is in communication with the smoke passage 403 through the first through hole.

Since the included angle formed between the extending direction of the intake passage 205 and the axial direction of the atomizer is less than 90 degree in this embodiment, the noise generated when the airflow flows into the atomizer is effectively reduced, and thus the user experience during smoking may be improved, and the smooth flowing of airflow inside the atomizer can be ensured. The direction of the airflow inside the atomizer can be referred to the direction indicated by the arrows shown in FIGS. 3, 9 and 10.

In a fourth embodiment, an electronic cigarette is provided.

As shown in FIG. 15, the electronic cigarette according to this embodiment includes an atomizer 1501 and a battery rod assembly 1502 for supplying power to the atomizer 1501.

The specific structure of the atomizer 1501 according to this embodiment is shown in the first embodiment to the third embodiment, and the specific structure of the atomizer 1501 is not limited in this embodiment.

The atomizer 1501 is arranged coaxially with the battery rod assembly 1502.

The atomizer 1501 and the battery rod assembly 1502 in this embodiment can be fixedly arranged, for example, two ends of the electric heating wire are electrically connected to the battery inside the battery rod assembly 1502 by leads, and there is no need to arrange an atomizer electrode inside the atomizer and a battery rod electrode inside the battery rod, i.e., the atomizer 1501 and the battery rod assembly 1502 are of a non-removable integral structure. The atomizer 1501 and the battery rod assembly 1502 may also be detachably connected.

The specific manner of the detachable connection is not limited in this embodiment, for example, the outer periphery wall of the outer electrode of the atomizer may be provided with a threaded section, an end of the battery rod assembly 1502 close to the threaded section is provided with a threaded bushing, and threads for cooperating with the threaded section are provided inside the threaded bushing, thus the atomizer can be screwed onto the battery rod assembly 1502.

An example that the atomizer 1501 and the battery rod assembly 1502 are detachably connected is illustrated in this embodiment.

Referring again to FIG. 15, the battery rod assembly 1502 includes a battery sleeve 1503. An end of the battery sleeve 1503 close to the atomizer is provided with a battery rod electrode 1504 electrically connected to the atomizer electrode, and a battery 1505 electrically connected to the battery rod electrode 1504 is provided in the battery sleeve 1503.

Preferably, the battery rod assembly 1502 includes an airflow sensor 1506 and a microcontroller.

The airflow sensor 1506 is configured to generate a trigger signal in a case that it is sensed that a user smokes through the suction nozzle cover.

When the user sucks in the smoke through the suction nozzle cover, the air pressure inside the battery rod assembly 1502 is reduced, and the airflow sensor 1506 can sense the situation that the air pressure is reduced and can generate the trigger signal accordingly.

The microcontroller is electrically connected to the battery 1505. The microcontroller is configured to control the battery 1505 to supply power to the electric heating wire according to the trigger signal.

Preferably, the battery rod assembly 1502 further includes a button arranged on the battery sleeve and configured to receive a pressing operation of the user.

The specific position of the button is not limited in this embodiment as long as it can receive the pressing operation of the user.

A micro switch is connected to the button and configured to generate a control signal in response to the pressing operation. The micro switch is electrically connected to the battery 1505, to allow the battery 1505 to supply power to the electric heating wire according to the control signal, thus the electronic cigarette can be controlled by either of the airflow sensor 1506 and the button, which is convenient for the users to use.

It can be appreciated by those skilled in the art that, for the convenience and simplicity of the description, the specific working process of the system, the device and the unit described above may refer to the corresponding process in the method embodiment described above, and will not be repeated.

The above embodiments are only used to illustrate the technical solutions of the present application, and are not intended to limit the present application. Although the present application is described in detail with reference to the above embodiments, it can be appreciated by those skilled in the art that, the technical solutions in the various embodiments described above can be modified, or a few of the technical features of the embodiments can be replaced equivalently; and the essence of the corresponding technical solutions will not depart from the spirit and scope of the technical solutions of the various embodiments of the present application with these modifications and replacements.

1. An atomizer, configured to form an electronic cigarette in combination with a battery rod assembly, wherein the atomizer comprises an atomizing sleeve, a cylindrical liquid storage member made of a liquid absorbing material and an atomizing assembly configured to atomize cigarette liquid to form smoke are arranged in the atomizing sleeve, and an atomizer electrode configured to be electrically connected to the battery rod assembly is connected to one end of the atomizing sleeve;
the atomizing assembly is arranged to be electrically connected to the atomizer electrode, and the atomizing assembly comprises an electric heating wire for atomizing the cigarette liquid and a liquid guiding member for delivering the cigarette liquid stored in the cylindrical liquid storage member to the electrical heating wire to be atomized, and the electrical heating wire is wound around the liquid guiding member; and
a smoke passage allowing the smoke to flow is arranged in an axial direction of the cylindrical liquid storage member and runs through the cylindrical liquid storage member, the cylindrical liquid storage member is provided with a guide groove, the guide groove is in communication with the smoke passage and an outer surface of the cylindrical liquid storage member, and the guide groove is configured to guide the atomizing assembly to be inserted into the cylindrical liquid storage member when assembling the atomizer, and to allow the electric heating wire wound around the liquid guiding member to be located inside the smoke passage.

2. The atomizer according to claim 1, wherein an end, corresponding to the atomizer electrode, of the cylindrical liquid storage member is provided with two first guide grooves opposite to each other, the two first guide grooves are respectively located at opposite sides of the smoke passage, and a guiding direction of each of the first guide grooves is parallel to the axial direction of the atomizer; and
the first guide grooves are configured to guide the atomizing assembly to be inserted into the cylindrical liquid storage member when assembling the atomizer, to allow the electric heating wire wound around the liquid guiding member to be located inside the smoke passage, and two ends of the liquid guiding member are respectively located in the two first guide grooves.

3. The atomizer according to claim 2, wherein the longitudinal section of each of the first guide grooves is n-shaped, rectangular or irregular.

4. The atomizer according to claim 1, wherein an end, corresponding to the atomizer electrode, of the cylindrical liquid storage member is provided with a second guide groove, the second guide groove is located at one side of the smoke passage; a first preset angle is formed between a guiding direction of the second guide groove and the axial direction of the atomizer, and the first preset angle is greater than 0 degree and less than or equal to 90 degrees; and
the second guide groove is configured to guide the atomizing assembly to be inserted into the cylindrical liquid storage member when assembling the atomizer, and to allow the electric heating wire wound around the liquid guiding member to be located inside the smoke passage.

5. The atomizer according to claim 2, wherein an end, adjacent to the smoke passage, of the first guide groove or the second guide groove is formed with an accommodating space having a shape matching with the shape of the atomizing assembly and configured to fix the atomizing assembly.

6. The atomizer according to claim 4, wherein an end, adjacent to the smoke passage, of the first guide groove or the second guide groove is formed with an accommodating space having a shape matching with the shape of the atomizing assembly and configured to fix the atomizing assembly.

7. The atomizer according to claim 1, wherein the cylindrical liquid storage member comprises a first cylindrical liquid storage sub-member and a second cylindrical liquid storage sub-member, and the first cylindrical liquid storage sub-member and the second cylindrical liquid storage sub-member are coaxially arranged in the axial direction of the atomizer, and are sequentially arranged in a direction towards the atomizer electrode;
the atomizing assembly is located between the first cylindrical liquid storage sub-member and the second cylindrical liquid storage sub-member, and the electric heating wire wound around the liquid guiding member is located inside the smoke passage; and
two ends of the liquid guiding member are extended to be inserted into the second cylindrical liquid storage sub-member, to allow the two ends of the liquid guiding member which are located inside the second cylindrical liquid storage sub-member to be located at two sides of the smoke passage.

8. The atomizer according to claim 7, wherein the second cylindrical liquid storage sub-member is provided with two third guide grooves, and the two third guide grooves are respectively located at two sides of the smoke passage;
a second preset angle is formed between a guiding direction of the third guide groove and the axial direction of the atomizer, and the second preset angle is greater than or equal to 0 degree and less than 90 degrees; and
the third guide groove is configured to guide two ends of the liquid guiding member to be inserted into the second cylindrical liquid storage sub-member when assembling the atomizer.

9. The atomizer according to claim 1, wherein an outer peripheral surface of the cylindrical liquid storage member is provided with an adhesion layer.

10. The atomizer according to claim 1, wherein a glass fiber tube is inserted in the cylindrical liquid storage member, and the smoke passage is located in a hollow portion of the glass fiber tube.

11. The atomizer according to claim 1, wherein the atomizer further comprises a mounting bracket located between the atomizing assembly and the atomizer electrode and made of conductive material; and
a first end of the mounting bracket is electrically connected to an end of the electric heating wire and a second end of the mounting bracket is electrically connected to the atomizer electrode, to allow the atomizer electrode to be electrically connected to the electric heating wire via the mounting bracket.

12. The atomizer according to claim 11, wherein the atomizer electrode comprises an outer electrode, an inner electrode inserted in the outer electrode, and an insulating ring arranged between the outer electrode and the inner electrode, the atomizer further comprises:
an atomizing seat, and two fourth guide groove are provided and run through the atomizing seat, the fourth guide grooves are configured to allow the second end of the mounting bracket to pass through the fourth guide groove when assembling the atomizer, to enable the second end of the mounting bracket passing through the fourth guide grooves to be electrically connected to the outer electrode and the inner electrode, respectively; and
a first through hole is provided and runs through the atomizing seat, and the first through hole is arranged coaxially with the smoke passage, and the first through hole is in communication with the smoke passage, to allow airflow entered from an end of the atomizer to flow into the smoke passage via the first through hole.

13. The atomizer according to claim 12, wherein a suction nozzle cover is arranged at an end of the atomizing sleeve away from the atomizer electrode, and the smoke atomized by the electric heating wire is configured to be delivered to the suction nozzle cover via the smoke passage;
the suction nozzle cover is provided with at least one air hole in communication with the smoke passage, to enable a user to inhale the smoke through the air hole;
a sealing ring for sealing the cigarette liquid stored in the cylindrical liquid storage member is arranged between the suction nozzle cover and the cylindrical liquid storage member, the sealing ring is provided with a second through hole, and the second through hole is arranged at a position corresponding to the smoke passage, to allow the air hole of the suction nozzle cover to be in communication with the smoke passage through the second through hole;
the outer electrode is provided with an intake passage, and two ends of the intake passage are respectively provided with an air inlet for allowing airflow outside the atomizer to flow into the intake passage and an air outlet for allowing airflow inside the intake passage to flow into the atomizer; and
an included angle less than 90 degree is formed between an extending direction of the intake passage and the axial direction of the atomizer, a distance between the air inlet and the electric heating wire is greater than a distance between the air outlet and the electric heating wire, and the intake passage is in communication with the smoke passage through the first through hole.

14. The atomizer according to claim 11, wherein the mounting bracket comprises two support columns arranged in parallel and spaced apart from each other, a first end of each of the support columns is provided with an insertion hole, to allow a respective end of the electric heating wire to be inserted in the insertion hole; and
a portion of the electric heating wire inside the insertion hole is fixedly connected to the first end of the support column by welding or riveting.

15. The atomizer according to claim 11, wherein the mounting bracket comprises two support columns arranged in parallel and spaced apart from each other, a first end of each of the support columns is arranged in parallel with a respective end of the electric heating wire in a radial direction of the atomizer; and
the respective end of the electric heating wire is fixedly connected to the first end of the support column by welding or riveting.

16. The atomizer according to claim 11, wherein the mounting bracket comprises two support columns arranged in parallel and spaced apart from each other, a first end of each of the support columns is provided with an arc-shaped section having an arc-shaped cross-section, and the arc-shaped section comprises an inward recessed portion;
the inward recessed portion of the arc-shaped section faces a respective end of the electric heating wire, and the inward recessed portion of the arc-shaped section is arranged in parallel with the end of the electric heating wire in a radial direction of the atomizer; and
the respective end of the electric heating wire is fixedly connected to the inward recessed portion of the arc-shaped section by welding or riveting.

17. The atomizer according to claim 1, wherein the cylindrical liquid storage member is formed by a solid polyhedron provided with the smoke passage and the guide groove, or a rotating body provided with the smoke passage and the guide groove, or a hollow cylinder provided with the guide groove in communication with a hollow portion of the hollow cylinder, or the cylindrical liquid storage member is integrally formed.

18. An electronic cigarette, comprising an atomizer and a battery rod assembly for supplying power to the atomizer, and the atomizer being arranged coaxially with the battery rod assembly, wherein the atomizer comprises an atomizing sleeve, a cylindrical liquid storage member made of a liquid absorbing material and an atomizing assembly configured to atomize cigarette liquid to form smoke are arranged in the atomizing sleeve;
the atomizing assembly comprises an electric heating wire for atomizing the cigarette liquid and a liquid guiding member for delivering the cigarette liquid stored in the cylindrical liquid storage member to the electrical heating wire to be atomized, and the electrical heating wire is wound around the liquid guiding member; and
a smoke passage allowing the smoke to flow is arranged in an axial direction of the cylindrical liquid storage member and runs through the cylindrical liquid storage member, the cylindrical liquid storage member is provided with a guide groove, the guide groove is in communication with the smoke passage and an outer surface of the cylindrical liquid storage member, and the guide groove is configured to guide the atomizing assembly to be inserted into the cylindrical liquid storage member when assembling the atomizer, and to allow the electric heating wire wound around the liquid guiding member to be located inside the smoke passage.
